(19) United States
(12) Patent Application Publication
(10) Pub. No.: US 2017/0247774 A1
(43) Pub. Date: Aug. 31, 2017

(54) CONTINUOUS TAILOR HEAT-TREATED BLANKS

(71) Applicant: GM Global Technology Operations LLC, Detroit, MI (US)

(72) Inventors: Anil K. Sachdev, Rochester Hills, MI (US); Tyson W. Brown, Royal Oak, MI (US)

(73) Assignee: GM Global Technology Operations LLC, Detroit, MI (US)

(21) Appl. No.: 15/054,913

(22) Filed: Feb. 26, 2016

(51) Int. Cl. C21D 9/00; C22F 1/06; C22F 1/04; C21D 1/42; C21D 1/40; B60J 5/04; B23K 26/38; B62D 29/00; B62D 25/04; B62D 25/06; B62D 25/10; C22F 1/18; C21D 1/34

(52) U.S. Cl. CPC C21D 9/0068; C22F 1/183; C22F 1/06; C22F 1/04; C21D 1/42; C21D 1/40; C21D 1/34; B23K 26/38; B62D 29/007; B62D 29/008; B62D 25/04; B62D 25/06; B62D 25/10; B60J 5/0483; B23K 2201/006

(57) ABSTRACT

Processes for forming blanks having tailored properties in localized areas are provided. The blanks are then formed into three-dimensionally shaped components (e.g., high-strength automotive parts). A sheet of high-strength metal alloy may be selectively heated in a first region to a temperature below a melting point of the metal alloy with a heat source, while a second region of the sheet adjacent to the first region remains unheated. The selective heating creates a first region of the metal alloy having at least one material property distinct from the second region. After the sheet is cut to form a blank, the blank comprises a portion of the first region and a portion of the second region. In this manner, a plurality of distinct tailored regions may be formed on each blank. The process may be continuous or semi-continuous and further include cutting of blanks from the sheet. High-strength structural components are also provided.

### FIELD

The present disclosure relates to tailored heat-treated metal alloy blanks, methods for making them, and structural components made therefrom.

### BACKGROUND

This section provides background information related to the present disclosure which is not necessarily prior art.

In various manufacturing processes, such as manufacturing in the automobile industry, sheet metal panels or blanks may be stamped, where the sheet metal panel is pressed between a pair of dies, to create a complex three-dimensional shaped component. A sheet metal blank is usually first cut from a coil of metal material. The sheet metal material is chosen for its desirable characteristics, such as strength, ductility, and other properties related to the metal alloy.

Different techniques have been used to reduce the weight of a vehicle, while still maintaining its structural integrity. For example, tailor-welded blank assemblies are commonly used to form structural components for vehicles that need to fulfill specialized load requirements. For example, the B-pillar structural component of a car body desirably exhibits a relatively high structural rigidity in the areas corresponding to the body of the occupant, while having increased deformability in the lower region at or below the occupant's seat to facilitate buckling of the B-pillar below seat level when force or impact is applied. As the structural component has different performance requirements in different regions, such a component has been made with multiple distinct pieces assembled together to form what is known as a “tailored blank assembly” or “tailored weld assembly” (also often referred to as a “tailor welded blank,” or “tailor welded coil”). By way of non-limiting example, tailor welded blank assemblies may be used to form structural components in vehicles, for example, structural pillars (such as A-pillars, B-pillars, C-pillars, and/or D-pillars), hinge pillars, vehicle doors, roofs, hoods, trunk lids, engine rails, and other components with high strength requirements.

A tailored blank assembly typically includes at least one first metal sheet or blank and a second metal sheet or blank having at least one different characteristic from the first sheet. For example, steel blanks or steel strips having different strength, ductility, hardness, thicknesses, and/or geometry may be joined. After joining, the desired contour or three-dimensional structure is created, for example, by a cold forming process or hot forming process (e.g., like the stamping process described above). Thus, adjoining edges of the first and second sheets may be mechanically interlocked together, for example, by making a weld, junction, or other connection along the adjoining edges to interlock them with one another. Thereafter, the permanently affixed sheets or blanks may be processed to make a shaped or formed sheet metal assembly product. Notably, the tailor blank assembly is not limited to solely two sheets or blanks, rather three or more sheets or blanks may be joined together and shaped to form the assembly.

However, creating tailor blank assemblies is relatively cost-intensive due to the numerous steps and manufacturing processes involved. For example, the initial work piece blanks need to be individually cut, then joined in an assembly process, followed by the forming or shaping processes. In addition, issues with the structural component may potentially arise due to the presence of a joint or junction, such as a weld line. For example, the weld line or connection between the blanks may provide a site for localized strain that may alter the properties of the structural component and/or potentially cause premature failure. Further, in subsequent hot forming processes, the effect of the heat from welding may cause changes in the welding seam that can ultimately lead to softening at the welding seam(s) in the finished component, which could potentially compromise the quality and functionality of such a tailor blank assembly. It would be desirable to develop alternative new methods for forming structural components that must exhibit variable properties in different regions, especially high-strength components that can replace tailor blank assemblies.

### SUMMARY

This section provides a general summary of the disclosure, and is not a comprehensive disclosure of its full scope or all of its features.

In certain variations, the present disclosure provides a method of forming a tailored precursor of a metal blank. The method comprises selectively heating a sheet of high-strength metal alloy in a first region to a temperature below a melting point of the metal alloy with a heat source. A second region of the sheet adjacent to the first region remains unheated. The selective heating thus creates a first region of the metal alloy having at least one material property distinct from the second region, so that after the sheet is cut to form a blank, the blank comprises a portion of the first region and a portion of the second region.

In other variations, the present disclosure provides another method of forming a tailored precursor of a metal blank. The method comprises selectively heating a sheet of high-strength metal alloy in a first region to a temperature below a melting point of the metal alloy with a heat source. A second region of the sheet adjacent to the first region remains unheated. The selective heating thus creates a first region of the high-strength metal alloy having at least one material property distinct from the second region. The method further comprises cutting the sheet to form a blank that comprises a portion of the first region and a portion of the second region.

In other aspects, the present disclosure provides a high-strength structural automotive component having a unitary three-dimensional body portion formed of a high-strength metal alloy. A first region of the unitary three-dimensional body portion exhibits at least one material property distinct from a second region. The second region desirably has a strength of greater than or equal to about 1,100 MPa to less than or equal to about 2,000 MPa and the unitary three-dimensional body portion is free of any welds, joints, or other connections. In certain aspects, the unitary three-dimensional body portion may have a substantially uniform thickness.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 shows a representative front view of a high-strength structural component in the form of a conventional tailor weld assembly B-pillar for an automobile.

FIG. 2 shows a side view of the high-strength structural component in FIG. 1.

FIG. 3 shows a simplified exemplary metal processing system for conducting selective heating methods of metal alloy sheets in accordance with certain aspects of the present disclosure to have two distinct regions with distinct material properties.

FIG. 4 shows a simplified exemplary metal continuous processing system for conducting selective heating methods of metal alloy sheets in accordance with certain aspects of the present disclosure and for cutting blanks, where the blanks have been treated to have two distinct regions with distinct material properties.

FIG. 5 shows another simplified exemplary metal continuous processing system for conducting selective heating methods of metal alloy sheets in accordance with certain aspects of the present disclosure and for cutting blanks, where the blanks have been treated to have three distinct regions with distinct material properties.

FIG. 6 shows another simplified exemplary metal continuous processing system for conducting selective heating methods of metal alloy sheets in accordance with certain aspects of the present disclosure and for cutting blanks, where the blanks have been treated to have three distinct regions with distinct material properties.

FIG. 7 shows yet another simplified exemplary metal continuous processing system for conducting selective heating methods of metal alloy sheets in accordance with certain aspects of the present disclosure and for cutting blanks, where the blanks have been treated to have three distinct regions with distinct material properties.

FIG. 8 shows a front view of a high-strength structural component formed in accordance with certain aspects of the present disclosure in the form of a hinge-pillar for an automobile.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

It should be understood for any recitation of a method, composition, device, or system that “comprises” certain steps, ingredients, or features, that in certain alternative variations, it is also contemplated that such a method, composition, device, or system may also “consist essentially of” the enumerated steps, ingredients, or features, so that any other steps, ingredients, or features that would materially alter the basic and novel characteristics of the invention are excluded therefrom.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. If, for some reason, the imprecision provided by “about” is not otherwise understood in the art with this ordinary meaning, then “about” as used herein may indicate a possible variation of up to 5% of the indicated value or 5% variance from usual methods of measurement.

As used herein, the term “composition” refers broadly to a substance containing at least the preferred metal elements or compounds, but which optionally comprises additional substances or compounds, including additives and impurities. The term “material” also broadly refers to matter containing the preferred compounds or composition.

In addition, disclosure of ranges includes disclosure of all values and further divided ranges within the entire range, including endpoints and sub-ranges given for the ranges.

Example embodiments will now be described more fully with reference to the accompanying drawings.

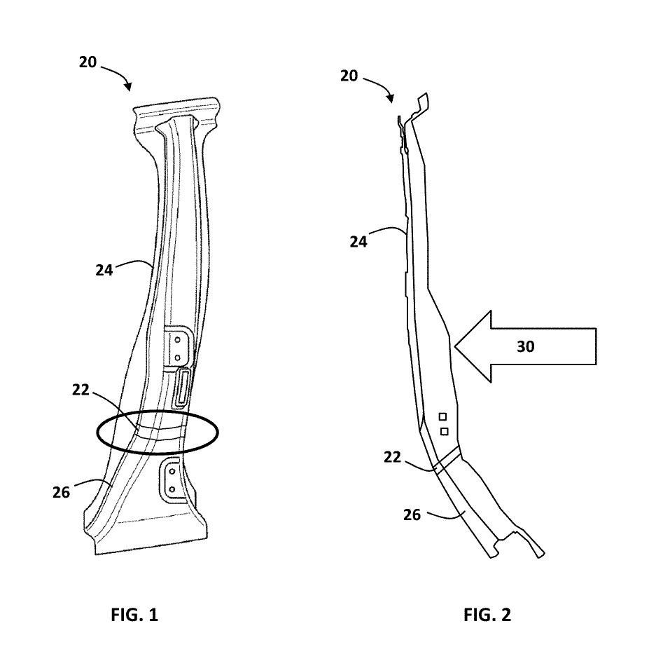

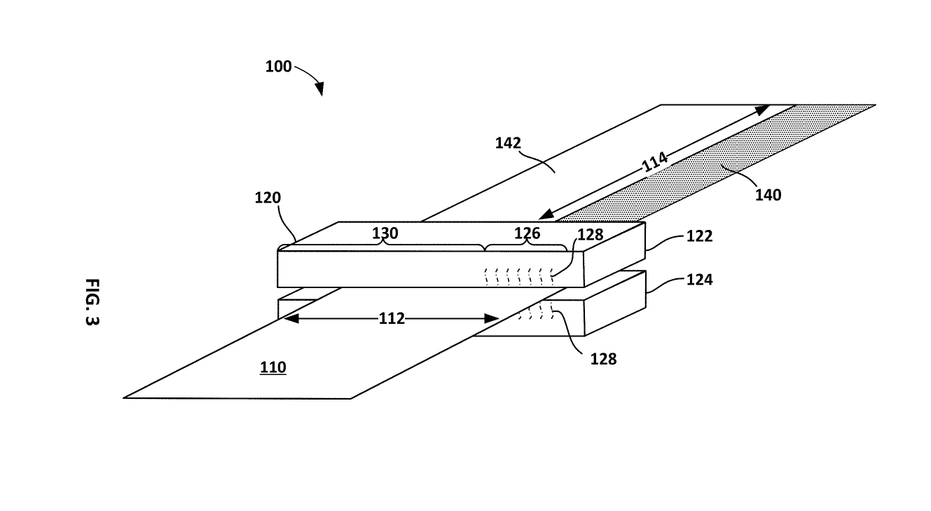

Referring to FIGS. 1 and 2, by way of background, a representative high-strength structural component in the form of a conventional tailor weld assembly B-pillar 20 for an automobile is shown. A representative joint or weld line 22 is shown mechanically coupling and joining a first metal piece 24 to a distinct second metal piece 26. It should be noted that FIGS. 1 and 2 show representative simplified versions of the B-pillar 20 and may have many additional parts joined together to form the B-pillar 20, but the main components will include the first metal piece 24 welded to the second metal piece 26 at weld line 22 as shown. The B-pillar 20 should have extreme strength in its upper section corresponding to first metal piece 24, but a balance of strength and formability in its lower section corresponding to second metal piece 26. Typically, the first metal piece 24 and the second metal piece 26 are of different composition or heat treatment to attain such different properties. In other cases, the first metal piece 24 and the second metal piece 26 have significantly different thicknesses to achieve such different material properties. The combination of these different properties promotes buckling at a desired location when a force or impact 30 is applied to the B-pillar 20, which may correspond to seat level within the interior of the vehicle to protect the occupant(s) after the force or impact 30 is applied. As noted above, the tailor blank assembly process involves numerous manufacturing processes, including formation of the blanks, joining of the blanks, and then forming of the three-dimensional shape of the component, which makes manufacturing more lengthy, complex, and costly. Further, the tailor-welding process has limited formability and can potentially introduce weak regions or other sites for localized strain.

In accordance with certain aspects of the present disclosure, methods for forming a tailored precursor of a metal blank from a sheet of metal alloy are provided. A sheet, as used herein, may be a coil of metal alloy or other bulk metal alloy materials not yet cut into individual blanks. In certain aspects, the metal blank can be further processed to form a high-strength component, such as an automotive component. The main portion of the high-strength component can be a unitary three-dimensional body. As referred to herein, a “unitary” structure is one having at least a portion that is constructed from a single blank. Notably, other components may be attached to unitary structure. While the unitary high-strength structures are particularly suitable for use in components of an automobile or other vehicles (e.g., motorcycles, boats, tractors, buses, motorcycles, mobile homes, campers, and tanks), they may also be used in a variety of other industries and applications, including aerospace components, consumer goods, office equipment and furniture, industrial equipment and machinery, farm equipment, or heavy machinery, by way of non-limiting example. Non-limiting examples of vehicles that can be manufactured by the current technology include automobiles, tractors, buses, motorcycles, boats, mobile homes, campers, and tanks. Other exemplary structures that have frames that can be manufactured by the current technology include buildings, such as houses, offices, sheds, warehouses, and devices. The high-strength component that is formed in accordance with certain aspects of the present disclosure has a substantially uniform thickness, meaning that a thickness of the high-strength component formed from a blank may have slight variations or deviations due to inadvertent manufacturing variability (e.g., specific thicknesses across the part vary less than or equal to about 1-2% of the average overall thickness).

In certain aspects, the present disclosure provides a method of forming a tailored precursor of a blank comprising a metal alloy. By “tailored,” it is meant that the mechanical properties of the blank are preselected so that a first region of the metal alloy has at least one material property distinct from the second region. Material properties may include by way of non-limiting example, tensile strength, yield strength, stiffness, ductility, elongation, formability, energy absorption, and the like, as well as combinations thereof. Exemplary heat treatments can increase the formability in one region of the sheet that will form a blank (albeit while losing some strength) that requires large deformation, while preserving the high strength of the original regions of the blank in the remaining portions of the sheet. For example, an automotive structural B-pillar should have extreme strength in its upper section, but a balance of strength and formability in its lower section. Thus, the formability limitations of a complex part can be overcome by tailoring the mechanical properties via selective heat treatment.

The method may include selectively heating a sheet of a metal alloy, such as a high-strength metal alloy. The high-strength metal alloy may be selected from the group consisting of: high-strength steel alloys, aluminum alloys, magnesium alloys, titanium alloys, and combinations thereof. Representative high-strength metal alloys may include advanced high strength steels, such as third generation advanced high strength steels, like quenched and partitioned (Q&P) and medium-manganese steels, transformation induced plasticity (TRIP) steel, like TRIP 690 and TRIP 780, dual phase (DP) steel, complex phase (CP) steel, high-strength low alloy (HLSA) steel, martensitic (MS) steel, 6000 series aluminum alloys, 7000 series aluminum alloys, and the like.

In Table 1, representative heat treatment temperature ranges are provided for certain alloys of interest:

TABLE 1

| ALLOY | LOW | HIGH |
|---|---|---|
| MATERIAL | TEMPERATURE | TEMPERATURE |
| Steel | 250° C. | 725° C. |
| Aluminum | 100° C. | 650° C. |
| Magnesium | 100° C. | 625° C. |
| Titanium | 200° C. | 1,200° C. |

Thus, for a given alloy, the selective heating may raise the temperature of the sheet in the first region to greater than or equal to the low (or minimum) temperature in Table 1 to less than or equal to the high (or maximum) temperature in Table 1.

In certain variations, the high-strength metal alloy comprises a high-strength steel alloy, so that the selective heating raises the temperature of the sheet to greater than or equal to about 250° C. in the first region. In other variations, the high-strength metal alloys comprises an aluminum alloy and the selective heating raises the temperature of the sheet to greater than or equal to about 100° C. in the first region.

In certain variations, the present disclosure provides a method of forming a tailored precursor of a metal blank. In such a method, a sheet of high-strength metal alloy is selectively heated in a first region by a heat source. The selective heating may be to a temperature below a melting point of the metal alloy. A second region of the sheet adjacent to the first region remains unheated. The first region and the second region are adjacent to one another across a width of the sheet, so that the selective heating actively occurs width-wise across the sheet. As the sheet is processed, the first region and the second region will be adjacent to one another width-wise and extend length-wise down the sheet. The selective heating thus creates a first region of the high-strength metal alloy having at least one material property distinct from the second region.

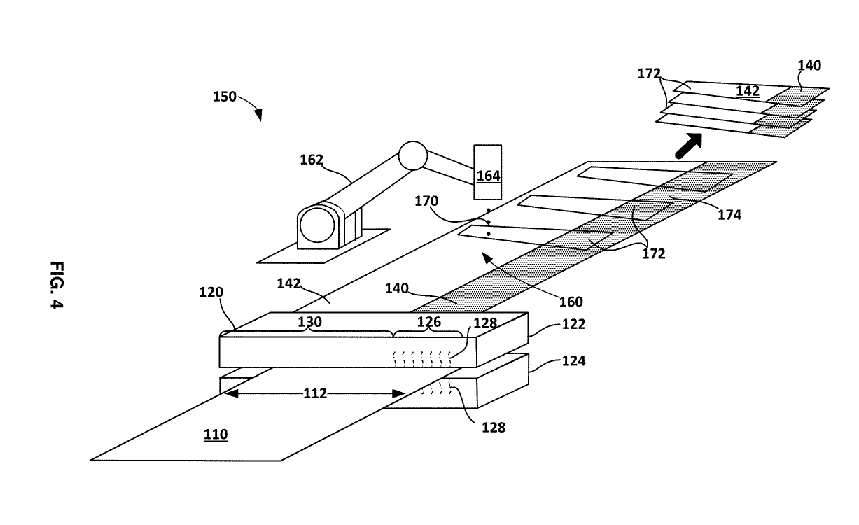

With reference to FIG. 3, a simplified exemplary metal processing system 100 for conducting such a method is shown. The system 100 conveys a sheet 110 of metal alloy towards a heat source 120. The sheet 110 may be part of a coil (e.g., an elongated strip), thus an uncoiling station (not shown) may uncoil the sheet 110 upstream of the heat source 120. While not shown, a variety of known conventional conveyors and rollers may be used to transport the sheet 110 through the metal processing system 100. Notably, in alternative variations, the sheet 110 may be pre-blanked before entering the metal processing system 100, for example, it may be a blank that has small tabs that can get snapped off or can be pre-cut blanks delivered on a conveyor belt.

The heat source 120 includes an upper section 122 and a lower section 124. The sheet 110 passes between the upper section 122 and the lower section 124. In accordance with the present disclosure, a heat source 120 is selected that has the ability to only selectively apply heat in select areas across a width 112 of sheet 110. The heat source 120 may include heaters or other sources of energy that when directed towards sheet 110 cause heating. In alternative variations, one or more heat sources may instead be selectively placed across portions of the width 112 of sheet 110, so that certain preselected areas may have heat applied (or not applied) by the one or more heat sources. As shown, the heat source 120 is activated in a first zone 126 and thus applies heat 128 in a direction towards the sheet 110. In a second zone 130, the heat source is deactivated and no heat 128 is applied to the passing sheet 110. The heat 128 is generated by both the upper section 122 and the lower section 124 in the first zone 126. However, it should be noted that in alternative embodiments, a single heat source may only be positioned over the top or bottom of the sheet 110 or only one of the upper section 122 or the lower section 124 is activated within the first zone 126. Suitable but non-limiting heat sources that are capable of selective activation of the heat include those selected from the group consisting of: an induction coil heat, an infrared emitter, an electric resistance heater, and combinations thereof.

The selective heating in the first zone 126 may thus heat a first region 140 of the sheet 110 to a temperature below a melting point of the metal alloy, such as the ranges of temperatures previously specified in Table 1. In this manner, the selective heating may temper the high-strength metal alloy in the first region 140. The first region 140 may then be cooled under ambient temperature and pressure conditions, or may be forced air, water, or spray-assisted cooled, by of example. A second region 142 of sheet 110 remains unheated as is passes under the second zone 130 of the heat source 120. The first region 140 is adjacent to the second region 142 across the width 112 of the sheet 110. The first region 140 and the second region 142 respectively extend along a length 114 of the treated portion of the sheet 110. Selective heating thus controls formation of a first region 140 of the metal alloy having at least one material property distinct from the second region 142, as will be discussed further below. The selectively heated first region 140 may have a width of greater than or equal to about 10 cm to less than or equal to about 3 meters. The length selectively heated first region 140 may correspond to the length of the sheet and thus, may be of any length including an entire strip of coiled of metal material.

It should be noted that a boundary or gradient zone may be formed between the first region 140 and the second region 142. The boundaries between such regions have a property gradient, rather than a discrete change as occurs in tailor-welding, and thus advantageously the boundary or transition zone does not form a site for localization of strain. The sheet 110 having first region 140 and second region 142 may then be further processed, for example, by entering a cutting station to form blanks or may be recoiled and the coil may be moved to another facility for later cutting into blanks.

In certain other variations, the present disclosure provides yet another method of forming a tailored precursor of a metal blanks similar to that described just above. In such a method, a sheet of high-strength metal alloy is selectively heated in a first region by a heat source. The selective heating may be to a temperature below a melting point of the metal alloy. A second region of the sheet adjacent to the first region remains unheated. The selective heating thus creates a first region of the high-strength metal alloy having at least one material property distinct from the second region. The method further comprises cutting the sheet to form a blank that comprises a portion of the first region and a portion of the second region.

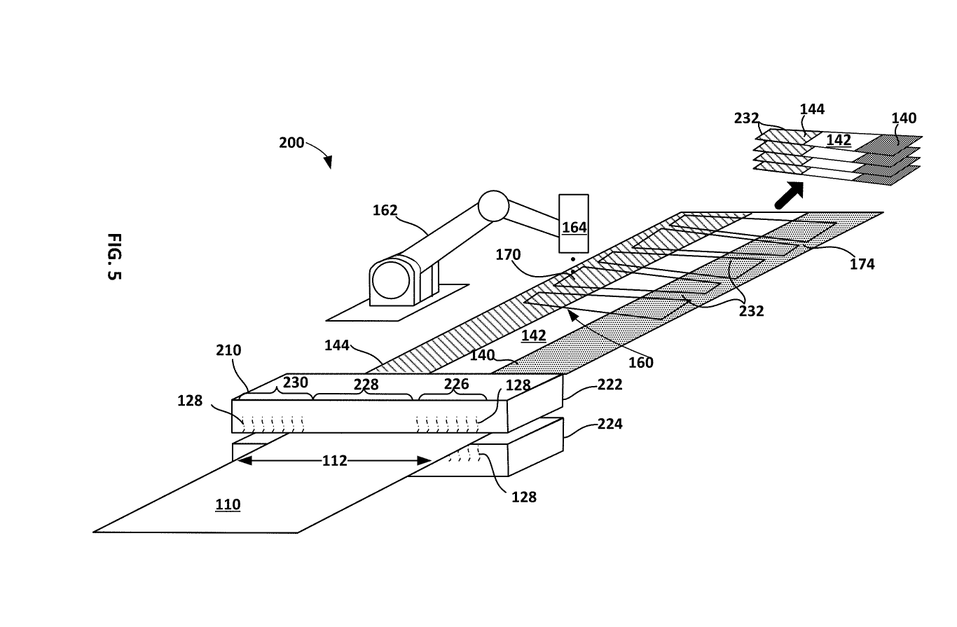

In certain other variations, the present disclosure provides yet another method of forming a tailored precursor of a metal blanks similar to that described just above. In such a method, in addition to selectively heating the sheet of metal alloy, the process further includes cutting the sheet to form a blank that comprises a portion of the first region and a portion of the second region. In certain aspects, the cutting may be laser cutting that occurs by applying laser energy onto a sheet. Such a method may be conducted within an exemplary simplified metal processing system 150 shown in FIG. 4. For brevity, any common elements shared between metal processing system 150 and the metal processing system 100 in FIG. 3 will likewise share the same reference numbers and will not be specifically discussed again, unless pertinent to the new aspects or features of metal processing system 150.

After sheet 110 passes through the heat source 120, it then is introduced to a cutting station area 160. The cutting station area 160 has a robotic computer-controlled laser cutting machine 162 that has a laser 164 capable of directing laser energy 170 towards the sheet 110. The computer-controlled laser cutting machine 162 can thus create predetermined patterns within the sheet 110 to form a plurality of blanks 172. The blanks 172 may be separated from scrap areas 174 and collected for later processing. It should be noted that cutting can also be achieved by other conventional cutting techniques for sheet metal, as are well known to those of skill in the art. Also, blanks may have shapes other than those shown in FIG. 4.

In certain aspects, such a method may be conducted continuously or semi-continuously. A continuous process desirably has a rate of greater than or equal to about 0.1 meter/minute to less than or equal to about 10 meters/minute. In a semi-continuous process, similar rates are desirable, but the sheet would also slow or come to a stop for periods of time between 1 second and 10 minutes to facilitate the application of heat. As noted above, the high-strength metal alloy may be a coil that is unrolled and processed continuously (or semi-continuously), for example, by first passing the coil of the high-strength metal alloy by the heat source followed by passing the coil through a cutting processor (e.g., a laser for the laser cutting). After the blanks 172 are formed, they may be transferred to downstream processing units (not shown in FIG. 4). For example, the method may further comprise forming a structural automotive component by processing the blank in a three-dimensional formation process. Such a three-dimensional formation process may include stamping, roll-forming, or press hardening, by way of non-limiting example.

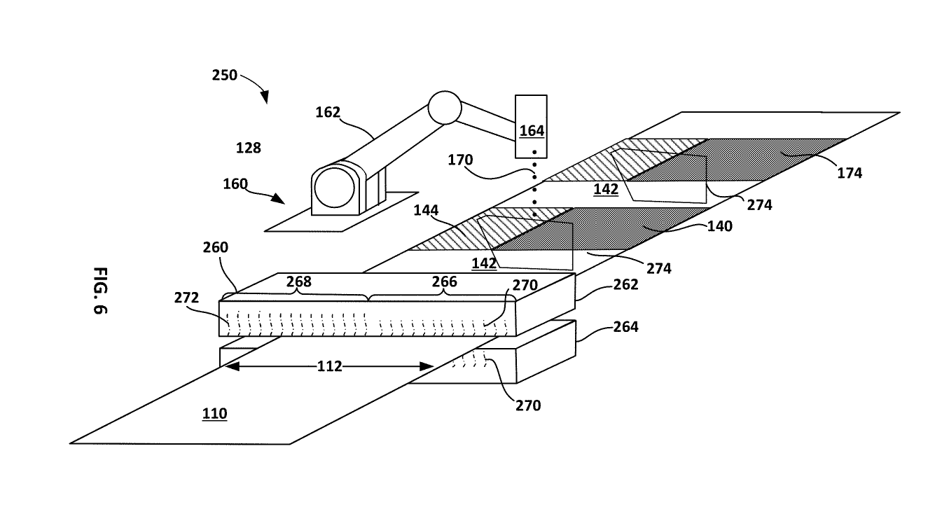

In yet other variations, the present disclosure provides another method of forming a tailored precursor of a metal blanks similar to those described just above. Such a method may be conducted on a simplified exemplary metal processing system 200 in FIG. 5. For brevity, any common elements in FIG. 5 that are shared between the metal processing system 200 and either metal processing system 100 in FIG. 3 or metal processing system 150 in FIG. 4 will likewise share the same reference numbers and will not be specifically discussed unless pertinent to the new features of metal processing system 200.

In such a method, the selective heating of sheet 110 of high-strength metal alloy, includes selectively heating a first region 140 to a first temperature below a melting point of the metal alloy with a heat source and selectively heating a third region 144 to a second temperature below a melting point of the metal alloy with a heat source 210. The first temperature and the second temperature may differ from one another or may be the same. Meanwhile, a second region 142 on the sheet 110 remains unheated. The first region 140 is adjacent to the second region 142. The third region 144 is also adjacent to the second region 142.

Thus, the heat source 210 includes an upper section 222 and a lower section 224. The sheet 110 passes between the upper section 222 and the lower section 224. In accordance with certain aspects of the present disclosure, a heat source 210 is selected that has the ability to only selectively apply heat in predetermined areas across a width 112 of sheet 110. The heat source 210 may include heaters or other sources of energy that when directed towards sheet 110 cause heating. As noted above, one or more heat sources may instead be selectively placed across portions of the width 112 of sheet 110, so that certain preselected areas may have heat applied (or not applied) by the one or more heat sources.

As shown, the heat source 210 is activated in a first zone 226 and thus applies heat 128 in a direction towards the sheet 110. In a second zone 228, the heat source is deactivated and no heat 128 is applied to the passing sheet 110. The heat source 210 is also activated in a third zone 230 and thus applies heat 128 in a direction towards the sheet 110. It should be noted that in an alternative embodiment, there may no heat source applied above the second zone 228 and the heat sources may only be present over the first zone 226 and third zone 230. The heat 128 is generated by both the upper section 222 and the lower section 224 in the first zone 226 and third zone 230. However, it should be noted that in alternative embodiments, a single heat source may only be positioned over the top or bottom of the sheet 110 or only one of the upper section 222 or the lower section 224 is activated within the first zone 226 and/or third zone 230. Any of the heat sources described previously is contemplated.

In certain variations, the first region 140 and the third region 144 are heated to different temperatures (so that the amount of heat 128 that achieves the first temperature in the first zone 226 is distinct from the amount of heat 128 from the third zone 230 to achieve the distinct second temperature). In this manner, the first region 140 and third region 144 differ from one another by at least one material property. Stated in another way, the first region 140 differs from the second region 142 by at least one first material property and from the third region 144 by at least second one material property (where the first material property and the second material property may be the same or different material properties). Likewise, the third region 144 differs from the first region 140 by at least one material property and the second region 142 by at least one material property (where the material properties may be the same or different from one another). For example, the first region 140 may exhibit a first strength, the second region 142 may exhibit a second strength, and the third region 144 may exhibit a third strength. Each of the first region 140, second region 142, or third region 144 may independently have a width of greater than or equal to about 10 cm to less than or equal to about 3 meters. It should be noted a width of each first region 140, second region 142, or third region 144 may be the same or distinct from one another.

In certain other variations, the first region 140 and the third region 144 are heated to the same temperature (so that the first temperature and the second temperature within the first zone 226 and the third zone 230 are the same). In this manner, the first region 140 and third region 144 have the same or similar material properties due to the selective heat treatment that vary from at least one material property of the untreated second region 142. For example, the first region 140 and third region 144 may have the same strength levels.

Like the methods above, the process may further include cutting the sheet 110 in a cutting station area 160 to form a blank 232. The blank 232 comprises a portion of the first region 140, a portion of the second region 142, and portion of the third region 144. In certain aspects, the cutting may be laser cutting that occurs by applying laser energy onto the sheet. Like in previous embodiments, the blanks 172 may be separated from scrap areas 174 and collected for later processing. In certain variations, the blanks 232 may be cut in a nested cut pattern (where blanks are fit together in opposite orientations to minimize scrap material areas 174) like that shown in FIG. 5. The nested cut pattern is particularly useful where the first region 140 and third region 144 have the same material properties, for example, the same strength levels. Other cut patterns are also contemplated for creating blanks having the first region 140, second region 142, and third region 144 are not limited to that shown in FIG. 5 or the other figures.

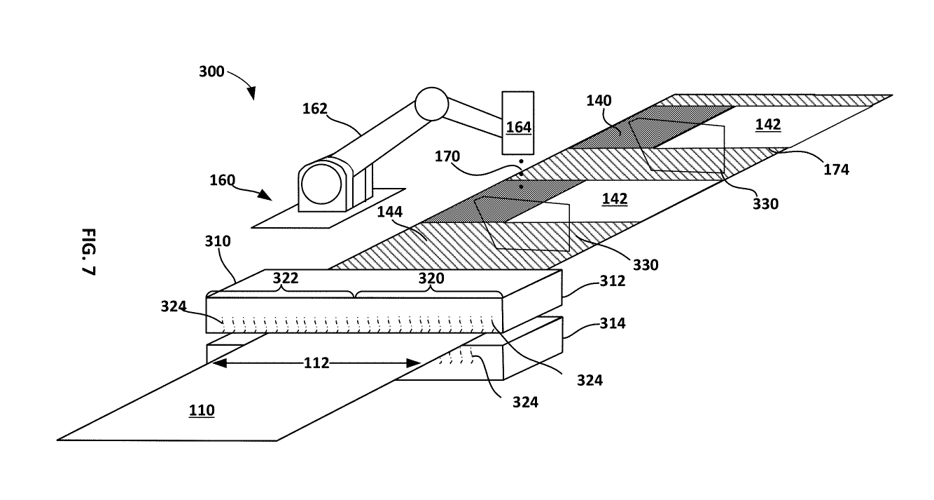

In yet other variations, the present disclosure provides another method of forming a tailored precursor of a metal blanks similar to those described just above. Such a method may be conducted on a simplified exemplary metal processing system 250 in FIG. 6. For brevity, any common elements in FIG. 6 that are shared between the metal processing system 250 and any of metal processing systems 100, 150, or 200 in FIG. 3, 4, or 5 will likewise share the same reference numbers and will not be specifically discussed unless pertinent to the new features of metal processing system 250.

In such a method, the selective heating of sheet 110 of high-strength metal alloy, includes selectively heating a first region 140 to a first temperature below a melting point of the metal alloy with a heat source and selectively heating a third region 144 to a second temperature below a melting point of the metal alloy with a heat source 210. The first temperature and the second temperature differ from one another. Meanwhile, a second region 142 on the sheet 110 remains unheated.

Thus, the heat source 260 includes an upper section 262 and a lower section 264. The sheet 110 passes between the upper section 262 and the lower section 264. In accordance with certain aspects of the present disclosure, a heat source 260 is selected that has the ability to only selectively apply heat in predetermined areas across a width 112 of sheet 110. Further, the heat source 210 may be deactivated for intervals of time. In combination with deactivating the heat source 210, the speed of sheet movement through the heat source can be altered to achieve substantially the same effect. As shown, the heat source 260 is activated both in a first zone 266 and a second zone 268. The first zone 266 applies heat 270 at a first intensity directed towards the sheet 110 to elevate the sheet 110 to a first temperature, while the second zone 268 applies heat 272 at a second intensity directed towards the sheet 110 to elevate the sheet 110 to a second temperature distinct from the first temperature. Thus, the first zone 266 and the second zone 268 are activated and subsequently deactivated concurrently. When the first zone 266 and second zone 268 are deactivated, no heat 128 is applied to the passing sheet 110.

Selective application of heat from the first zone 266 creates the first region 140. Selective application of heat from the second zone 268 creates a third region 144. The first region 140 is adjacent to the third region 144 and together they span across the entire width 112 of sheet 110. A second region 142 is formed intermittently at regular intervals where no heat is applied as the sheet 110 passes. The second region 142 spans across the entire width 112 of the sheet 110 in these regions. Further, the second region 142 is adjacent to the first region 140 and the third region 144 lengthwise. In this manner, multiple complex regions can be formed in the sheet 110.

Like the embodiments described above, the first region 140 and the third region 144 are heated to different temperatures (so that the amount of heat 270 that achieves the first temperature in the first zone 266 is distinct from the amount of heat 272 from the second zone 268 to achieve the distinct second temperature). In this manner, the first region 140 and third region 144 differ from one another by at least one material property. Stated in another way, the first region 140 differs from the second region 142 by at least one first material property and from the third region 144 by at least second one material property (where the first material property and the second material property may be the same or different material properties). Likewise, the third region 144 differs from the first region 140 by at least one material property and the second region 142 by at least one material property (where the material properties may be the same or different from one another). For example, the first region 140 may exhibit a first strength, the second region 142 may exhibit a second strength, and the third region 144 may exhibit a third strength. The first strength may be greater than the second strength, and the second strength may be greater than the third strength, by way of non-limiting example. Each of the first region 140, second region 142, or third region 144 may independently have a width of greater than or equal to about 10 cm to less than or equal to a width of a sheet or coil strip (typically about 2 m). It should be noted a width of each first region 140 and third region 144 may be the same or distinct from one another.

Like the methods above, the process may further include cutting the sheet 110 in a cutting station area 160 to form a blank 274. The blank 274 comprises a portion of the first region 140, a portion of the second region 142, and portion of the third region 144. In certain aspects, the cutting may be laser cutting that occurs by applying laser energy onto the sheet. Like in previous embodiments, the blanks 274 may be separated from scrap areas 174 and collected for later processing. The blanks 274 may be further processed downstream, including in a three-dimensional formation process to create a high-strength structural automotive component.

In yet other variations, the present disclosure provides yet another method of forming a tailored precursor of a metal blanks similar to those described in the context of FIG. 6. Such a method may be conducted on a simplified exemplary metal processing system 300 in FIG. 7. For brevity, any common elements in FIG. 7 that are shared between the metal processing system 300 and any of metal processing systems 100, 150, 200, or 250 in FIGS. 3, 4, 5, and 6 will likewise share the same reference numbers and will not be specifically discussed unless pertinent to the new features of metal processing system 300.

In such a method, the selective heating of sheet 110 of high-strength metal alloy, includes selectively heating a first region 140 to a first temperature below a melting point of the metal alloy with a heat source and selectively heating a third region 144 to a second temperature below a melting point of the metal alloy with the heat source 310. The first temperature and the second temperature differ from one another. Meanwhile, a second region 142 on the sheet 110 remains unheated.

Thus, a heat source 310 includes an upper section 312 and a lower section 314. The sheet 110 passes between the upper section 312 and the lower section 314. In accordance with certain aspects of the present disclosure, the heat source 310 is selected to have the ability to only selectively apply heat in predetermined areas across a width 112 of sheet 110. Further, the heat source 310 may be deactivated for intervals of time. As shown, the heat source 310 is activated both in a first zone 320 and a second zone 322. In a first operational mode, the first zone 320 and the second zone 322 apply heat 324 directed towards the sheet 110 to elevate the sheet 110 to a first temperature. In a second operational mode, only the second zone 322 applies heat 324 towards the sheet 110 to elevate the sheet to a second temperature, thus the heat 324 generated within the second zone 322 may have different intensity levels when applied in the first operational mode as compared to the second operational mode. Furthermore, the speed of the sheet moving through the heat source 310 may differ between the two operational modes, or remain constant. In the second operational mode, the first zone 320 is deactivated and no heat is applied to the corresponding regions of the sheet 110 below it.

Selective application of heat from the second zone 322 of the heat source 310 in the second operational mode creates the first region 140 where the metal alloy in the sheet 110 is raised to the first temperature. A second region 142 where no heat is applied is formed adjacent to the first region 140 across the width 112 of the sheet 110. A third region 144 is formed intermittently at regular intervals as the sheet 110 passes in the first operational mode, where heat 324 is applied by both the first zone 320 and second zone 322 of the heat source 310. The third region 144 spans across the entire width 112 of the sheet 110 in these regions. The third region 144 is adjacent to the first region 140 and the second region 142 lengthwise. Like the embodiment shown in FIG. 6, multiple complex selectively heated regions can be formed in the sheet 110 prior to further processing.

Also like the embodiments described above, the first region 140 and the third region 144 are heated to different temperatures (so that in the first operational mode, the amount of heat 324 that achieves the second temperature in the first zone 320 and the second zone 322 is distinct from the amount of heat 324 from the second zone 322 alone to achieve the distinct first temperature in the second operational mode). In this manner, the first region 140 and third region 144 differ from one another by at least one material property. Stated in another way, the first region 140 differs from the second region 142 by at least one first material property and from the third region 144 by at least one second material property (where the first material property and the second material property may be the same or different material properties). Likewise, the third region 144 differs from the first region 140 by at least one material property and the second region 142 by at least one material property (where the material properties may be the same or different from one another).

For example, the first region 140 may exhibit a first strength and thus may be high-strength, the second region 142 may exhibit a second strength and have a slightly lower strength than the first strength, but a high stiffness level, while the third region 144 may exhibit a third strength that is lower than the first and second strengths, but has a higher energy absorption ability. In certain aspects, where the metal alloy is an aluminum alloy, the unheated second region 142 has high-strength and stiffness; however, slight heating can further increase the strength of the aluminum alloy to form the first region 140. Further heating to a higher temperature increases diminishes strength of the aluminum alloy, but enhances flexibility and energy absorption in the third region 144. Each of the first region 140, second region 142, or third region 144 may independently have a width of greater than or equal to about 10 cm to less than or equal to the sheet or coil strip width (typically about 2 meters). It should be noted a width of each first region 140 and second region 142 may be the same or distinct from one another.

Like the methods above, the process may further include cutting the sheet 110 in a cutting station area 160 to form a blank 330. The blank 330 comprises a portion of the first region 140, a portion of the second region 142, and portion of the third region 144. In certain aspects, the cutting may be laser cutting that occurs by applying laser energy onto the sheet 110. Like in previous embodiments, the blanks 330 may be separated from scrap areas 174 and collected for later processing. The blanks 330 may be further processed downstream, including in a three-dimensional formation process to create a high-strength structural automotive component.

The methods of the present disclosure may be continuous or semi-continuous processes that allow formation of blanks having tailored properties in localized areas at a reduced cost relative to tailor-welding or heat treatment of individual blanks. For example, the methods of the present disclosure create blanks with tailored properties by heat treating selected widths or length sections of a sheet in a continuous or semi-continuous manner before blanking operations. The processes provided by the present teachings may thus enable higher strength (e.g., lower formability) materials, where high formability is only required locally. The processes of the present disclosure can be applied to most common structural sheet materials, like steel, aluminum, magnesium, and titanium, including high-strength alloys.

In certain aspects, the methods of the present disclosure including selectively heat treating a coil of metal alloy, such that different regions within the coil width or length acquire different mechanical properties suited for the specific design and function of the part ultimately formed. The blanks and parts formed in accordance with certain aspects of the present teachings can advantageously avoid manufacturing issues and limited formability that arise from conventional tailor-welding processes. For example, boundaries between regions will have a property gradient instead of a discrete change as in tailor-welding and thus, will not be a site for localization of strain. The present disclosure thus contemplates a method of heat treating a coil such that different regions within the coil width or length acquire different mechanical properties suited for a specific design and function of the part ultimately to be formed.

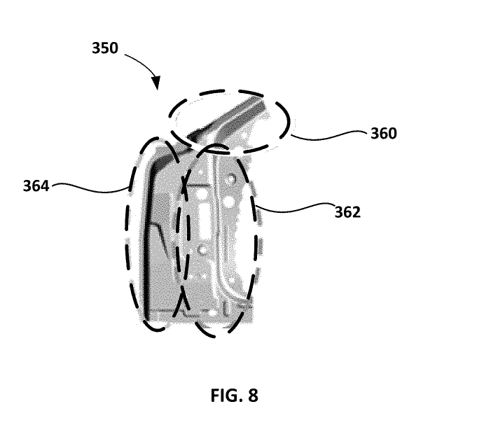

FIG. 8 shows a formed high-strength part 350 made from a selectively heated blank similar to blank 330 shown in FIG. 7. High-strength part 350 is a representative hinge pillar. High-strength part 350 has a first region 360, a second region 362, and a third region 364 generally corresponding to the first region 140, second region 142 and third region 144 described in FIG. 7. The first region 360 has been selectively heated to a first temperature below a melting point of the metal alloy. The second region 362 has not been heated during the processing techniques like those described above. The first region 360 of the metal alloy has at least one material property distinct from the second region 362, for example, strength. The third region 364 has been selectively heated to a second temperature distinct from the first temperature. The third region 364 has at least one material property distinct from the first region 360 and the second region 362.

For example, the first region 360 may exhibit a first strength and thus may be high-strength, the second region 362 may exhibit a second strength and have a high stiffness level, and the third region 364 may exhibit a third strength that is lower than the first and second strengths, but has a higher energy absorption ability. As noted above, the first region 360 may exhibit a first strength and thus may be high-strength, the second region 362 may exhibit a second strength and have a slightly lower strength than the first strength, but a high stiffness level, while the third region 364 may exhibit a third strength that is lower than the first and second strengths, but has a higher energy absorption ability.

In certain aspects, the present disclosure thus contemplates high-strength structural automotive components that may comprise a unitary three-dimensional body portion formed of a high-strength metal alloy. The unitary three-dimensional body portion has a first region exhibiting at least one material property distinct from a second region. The second region may have a strength of greater than or equal to about 1,100 MPa to less than or equal to about 2,000 MPa. The first region of the sheet of high-strength metal alloy may have an average tensile strength of less than or equal to about 1000 MPa and in certain variations, as low as 400 MPa. The unitary three-dimensional body portion is free of any welds, joints, or other connections. In certain aspects, the unitary three-dimensional body portion is three-dimensionally formed from a blank having a substantially uniform thickness, as discussed previously above. Further, the high-strength structural automotive component may be selected from the group consisting of: structural pillars, A-pillars, B-pillars, C-pillars, D-pillars, hinge pillars, vehicle doors, roofs, hoods, trunk lids, engine rails, and combinations thereof in certain variations.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method of forming a tailored precursor of a metal blank comprising:
selectively heating a sheet of high-strength metal alloy in a first region to a temperature below a melting point of the metal alloy with a heat source, wherein a second region of the sheet adjacent to the first region remains unheated, wherein the selectively heating creates a first region of the metal alloy having at least one material property distinct from the second region, so that after the sheet is cut to form a blank, the blank comprises a portion of the first region and a portion of the second region.

2. The method of claim 1, wherein the selective heating further includes selectively heating a third region with the heat source to create a third region having at least one material property distinct from the second region, wherein the third region is adjacent to the second region.

3. The method of claim 1, wherein the selective heating further includes selectively heating a third region with the heat source, wherein a first amount of heat applied to the first region by the heat source is distinct to a second amount of heat applied to the third region, so that the selective heating creates a third region having at least one material property distinct from both the first region and the second region.

4. The method of claim 1, wherein the selectively heating tempers the first region and the first region is cooled under ambient temperature and pressure conditions.

5. The method of claim 1, wherein the heat source is selected from a group of heaters selected from the group consisting of: an induction coil heat, an infrared emitter, an electric resistance heater, and combinations thereof.

6. The method of claim 1, wherein the first region has a width of greater than or equal to about 10 cm to less than or equal to about 3 meters.

7. The method of claim 1, wherein the high-strength metal alloy comprises a high-strength steel alloy, and the selective heating raises the temperature of the sheet to greater than or equal to about 250° C. in the first region.

8. The method of claim 1, wherein the high-strength metal alloy comprises an aluminum alloy and the selective heating raises the temperature of the sheet to greater than or equal to about 100° C. in the first region.

9. The method of claim 1, wherein the second region of the sheet of high-strength metal alloy has an average tensile strength of greater than or equal to about 1,100 MPa to less than or equal to about 2,000 MPa.

10. The method of claim 1, wherein the first region of the sheet of high-strength metal alloy has an average tensile strength of less than or equal to about 1,000 MPa.

11. A method of forming a tailored precursor of a metal blank comprising:
selectively heating a sheet of high-strength metal alloy in a first region to a temperature below a melting point of the metal alloy with a heat source, wherein a second region of the sheet adjacent to the first region remains unheated, wherein the selectively heating creates a first region of the high-strength metal alloy having at least one material property distinct from the second region; and
cutting the sheet to form a blank that comprises a portion of the first region and a portion of the second region.

12. The method of claim 11, wherein the cutting is laser cutting that occurs by applying laser energy onto the sheet.

13. The method of claim 11, wherein the sheet is a coil of the high-strength metal alloy and the method is conducted continuously or semi-continuously at a rate of greater than or equal to about 0.1 meter/minute to less than or equal to about 10 meters/minute.

14. The method of claim 11, wherein the sheet is a coil of the high-strength metal alloy and the method is conducted continuously or semi-continuously, including first passing the coil of the high-strength metal alloy by the heat source followed by passing the coil by a laser for the laser cutting.

15. The method of claim 11, wherein the high-strength metal alloy is selected from the group consisting of: high-strength steel alloys, aluminum alloys, magnesium alloys, titanium alloys, and combinations thereof.

16. The method of claim 11, further comprising forming a structural automotive component by processing the blank in a three-dimensional formation process.

17. The method of claim 11, wherein the selective heating further includes selectively heating a third region with the heat source to create a third region adjacent to the second region having at least one material property distinct from the second region.

18. The method of claim 17, wherein the sheet comprises the second region disposed between the first region and the third region and the cutting includes creating a nested blank pattern including a first blank comprising a portion of the first region and a portion of the second region and a second blank comprising a portion of the second region and a portion of the third region.

19. A high-strength structural automotive component comprising:
a unitary three-dimensional body portion formed of a high-strength metal alloy having a first region exhibiting at least one material property distinct from a second region, wherein the second region has a strength of greater than or equal to about 1,100 MPa to less than or equal to about 2,000 MPa and the unitary three-dimensional body portion is free of any welds, joints, or other connections.

20. The high-strength structural automotive component of claim 19, wherein the structural automotive component is selected from the group consisting of: structural pillars, A-pillars, B-pillars, C-pillars, D-pillars, hinge pillars, vehicle doors, roofs, hoods, trunk lids, engine rails, and combinations thereof.
